(19) United States
(12) Patent Application Publication
(10) Pub. No.: US 2026/0272239 A1
(43) Pub. Date: Sep. 17, 2026

(54) WET CLEANING APPARATUS AND METHOD

(71) Applicant: VERSUNI HOLDING B.V., Eindhoven (NL)

(72) Inventors: Albert AL-SHORACHI, Eindhoven (NL); Aaldert Geert ZIJLSTRA, Eindhoven (NL); Bastiaan Johannes DE WIT, Eindhoven (NL); Johannes Tseard VAN DER KOOI, Eindhoven (NL)

(73) Assignee: VERSUNI HOLDING B.V., Eindhoven (NL)

(21) Appl. No.: 18/707,135

(22) PCT Filed: Sep. 17, 2021
(86) PCT No.: PCT/EP2021/075614

§ 371 Date: May 2, 2024

(30) Foreign Application Priority Data
Sep. 17, 2020 (EP) 20196639.7

(51) Int. Cl. A47L 7/00; B01D 45/06

(52) U.S. Cl. CPC A47L 7/0023; B01D 45/06

(57) ABSTRACT

Provided is a wet cleaning apparatus (10), such as a wet vacuum cleaner, which uses a separator unit (18) for separating liquid and particles from a flow of air, e.g. a suction flow. The separator unit comprises a flow path member (36) and an outlet member (38) which adjoins or substantially adjoins the flow path member, and extends from the flow path member. The flow path member changes the flow direction of the flow of air such that any water and/or dirt particles entrained in the air are thrown against an interior surface portion (36A) of the flow path member. In this way, such water and/or dirt particles are separated from the flow of air. The outlet member has an opening to which the separated water and/or dirt particles are guided. The outlet member is arranged, when the apparatus is orientated for use, to guide and accumulate the separated water and/or dirt particles towards a region (52) at the opening. The separated water and/or dirt particles flow from the region towards a collection volume (28) along a first flow path (39). The air separated from the water and/or dirt particles is directed towards an air passage (22) which is spaced apart from the outlet member and the collection volume. A second flow path (32A) is provided for the separated air between the opening of the outlet member and the air passage, which second flow path is directed away from the first flow path. This assists to minimise or prevent re-entrainment of the water and/or dirt particles in the flow of air. Further provided is a method of separating water and/or dirt particles from a flow of air.

### FIELD OF THE INVENTION

This invention relates to wet cleaning apparatuses, and in particular wet vacuum cleaners. The invention also relates to a method of separating water and/or dirt particles from an airflow.

### BACKGROUND OF THE INVENTION

Traditionally, hard floor cleaning has involved first vacuuming the floor, followed by mopping it. Vacuuming removes the fine dust and coarse dirt, while mopping removes any very fine dust and stains.

There are now many available appliances on the market that claim to vacuum and mop in one go, and this is what is referred to by a “wet vacuum cleaner”. Many of these appliances have a vacuum nozzle for picking up the coarse dirt by means of an airflow and a (wet) cloth or brush for removing the stains. These wet cloths or brushes can be pre-wetted or can be wetted by the consumer but also in some cases they can be wetted by the appliance (by means of a liquid but also by means of steam).

The wet vacuum cleaner then needs to be able to collect moist dirt from the floor and transport it to the dirt container. This is achieved using the flow generated by a motor and fan arrangement. The moist dirt and liquid in the form of droplets needs to be separated from the flow. The moist dirt and liquid enters the dirt container whereas the remaining airflow passes through the fan and any post-filtering units, and exits the appliance.

It is known to use labyrinth-type, filter-type or cyclone-type separation units to separate liquid and moist dirt from the airflow.

The present disclosure relates to separator units in which the mixture of air and liquid/moist dirt is guided through a structure, in other words a flow path member, in which there is an enforced change of direction which causes the liquid/moist dirt to end up on the surface of a wall of the structure. In this way, droplets and streams of liquid form on the walls of the structure. By guiding the mixture through a geometry that forces it to change direction, liquid and solid will be spread outwardly because of centrifugal forces. However, since air velocities may be higher at the outer regions of the structure, there is a risk of the separated water/moist dirt mixing with the air again, which not only deteriorates the separation efficiency but also disturbs the airflow.

### SUMMARY OF THE INVENTION

The invention is defined by the claims.
According to examples in accordance with an aspect of the invention, there is provided a wet vacuum cleaner comprising a dirt inlet; a motor and fan for delivering suction to the dirt inlet; a separator unit for separating water and/or dirt particles from a flow of air generated by the suction; a collection volume for collecting the separated water and/or dirt particles, wherein the separator unit comprises: a flow path member having an interior surface portion, the flow path member being arranged to change a flow direction of the flow of air such that the water and/or dirt particles are flung against the interior surface portion and thereby separated from the air; and an outlet member extending from the flow path member to an opening, wherein the outlet member is arranged to guide and accumulate the separated water and/or dirt particles towards a region at the opening from which the separated water and/or dirt particles flow towards the collection volume along a first flow path when the apparatus is orientated for use; and wherein the apparatus comprises an air passage for passing the air separated from the water and/or dirt particles towards the motor and fan, the air passage being spaced apart from the outlet member and the collection volume, a second flow path being defined between the opening and the air passage, which second flow path is directed away from the first flow path.

By the outlet member accumulating the separated water and/or dirt particles towards the region at the opening of the outlet member, a controlled (first) flow path of the water and/or dirt particles is provided towards the collection volume. Moreover, by defining the second flow path of the separated air from the opening towards the air passage such that the second flow path is directed away from the first flow path, the risk of re-entrainment of the water and/or dirt particles in the airflow may be minimised.

The guiding and accumulating of the separated water and/or dirt particles to the region may be implemented in any suitable manner. In a non-limiting example, the opening is delimited by a slanted rim which is slanted such that the separated water and/or dirt particles flow around/along the slanted rim towards the region. In this case, the region may include, or be defined by, a lowermost point on the slanted rim towards which the water and/or dirt particles in the outlet member flow when the apparatus is orientated for use.

As well as the slanted rim assisting to guide and accumulate the separated water and/or dirt particles towards the region, the slanted rim may further assist in directing the flow of separated air away from the first flow path, since the resistance to airflow may be higher on the side of the outlet member towards which the water and/or dirt particles are guided by the slanted rim.

Alternatively or additionally, the outlet member may comprise a water guiding element, the water guiding element being arranged on or in an inner surface of the outlet member and configured to guide the separated water and/or dirt particles towards the region. The water guiding element may, for example, comprise at least one of a rib protruding from the inner surface of the outlet member, and a groove in the inner surface of the outlet member.

In an embodiment, a flow-through area of the outlet member increases towards the opening. By increasing the cross-sectional area of the outlet member towards the opening, the liquid may be exposed to a lower speed airflow, and may thus be less likely to be re-entrained in the airflow.

The outlet member may have a first side opposing a second side. The first side may extend to the region, with the second flow path extending from the opening at the second side and towards the air passage. In this way, the second flow path may be substantially prevented from crossing the first flow path. Rather, the second flow path is directed away from the first flow path.

More generally, the second flow path of the separated air from the opening towards the air passage may be at least partly determined by the spatial arrangement of the air passage relative to the opening. For example, the air passage may be positioned such that a shorter flow path is provided from the opening at the second side than at the first side.
Alternatively or additionally, the wet cleaning apparatus may comprise a shielding member which extends from the first side, and thereby blocks the flow of air along the first side towards the air passage. In this manner, the shielding member assists to define the second flow path along the second side of the outlet member and towards the air passage.
The outlet member may comprise: a first outer surface at the opening, which first outer surface is substantially perpendicular to an airflow direction within the outlet member; and a curved surface for guiding the separated water and/or dirt particles in the outlet member to the first outer surface. Droplets may thus be guided to the first outer surface, and may flow along the first outer surface towards the region.

The term “substantially perpendicular” in this context may mean that the outer surface is angled, for instance, at 90°±10° to the airflow direction within the outlet member.
Alternatively or additionally, the first outer surface opposes, e.g. faces, the collection volume.
The outlet member may further comprise a second outer surface which meets the first outer surface at an edge. This defined edge may assist to retain the droplets on the first outer surface, partly as a consequence of their wetting properties, thereby to assist the passage of the droplets along the first outer surface towards the region.

The wet cleaning apparatus may comprise a tube for delivering the airflow to the separator unit. In one set of non-limiting examples, a cup receives an end of the tube. In this case, the interior surface portion of the flow path member is defined by an interior surface of the cup which is spaced apart from the end of the tube. Moreover, the outlet member may be defined by a downstream portion of the cup, which downstream portion comprises a rim of the cup. The rim of the cup may, for example, be slanted such as to define the slanted rim which delimits the opening of the outlet member.

In another set of examples, the flow path member is defined by a curved tube section having an upstream end and a downstream end, with the upstream end adjoining the tube. The flow path member adjoins the downstream end of the curved tube section.

More generally, the wet cleaning apparatus may comprise a container whose volume includes the collection volume. The container may further house at least part of the separator unit.

The apparatus may, for example, further comprise a partition. In such an example, the collection volume is delimited by walls of the container and the partition, with the first flow path being directed past the partition and towards the collection volume.

The container may be partly delimited by an end wall in which the air passage is provided, with the end wall opposing the collection volume across the container. Thus, the air passage may be spaced apart from the collection volume across the container.

According to another aspect there is provided a method of separating water and/or dirt particles from a flow of air using a flow path member having an interior surface portion, an outlet member extending from the flow path member to an opening, a collection volume, and an air passage spaced apart from the outlet member and the collection volume, the method comprising: generating a flow of air comprising entrained water and/or dirt particles; using the flow path member to change a flow direction of the flow of the air such that the water and/or dirt particles are flung against the interior surface portion and thereby separated from the air; using the outlet member to accumulate and guide the separated water and/or dirt particles towards a region at the opening from which the separated water and/or dirt particles flow towards the collection volume along a first flow path, wherein the air separated from the water and/or dirt particles is passed towards the air passage along a second flow path which is directed away from the first flow path.

### BRIEF DESCRIPTION OF THE DRAWINGS

Examples of the invention will now be described in detail with reference to the accompanying drawings, in which:

FIG. 1 schematically depicts a wet cleaning apparatus according to an example;

FIG. 2 provides a perspective view of the separator unit included in the wet cleaning apparatus shown in FIG. 1, with an inset which provides an enlarged view of the rim of an outlet member included in the separator unit;

FIG. 3 provides a cross-sectional view of part of a wet cleaning apparatus including a separator unit according another example;

FIG. 4 provides a perspective view of the part shown in FIG. 3;

FIG. 5 provides a cross-sectional view of part of a wet cleaning apparatus including a separator according to still another example;

FIG. 6 provides a cross-sectional view of part of a wet cleaning apparatus including a separator according to yet another example;

FIG. 7 shows a wet cleaning apparatus according to another example;

FIG. 8 provides a cross-sectional view of the separator unit included in the wet cleaning apparatus shown in FIG. 7;

FIG. 9 shows a cross-sectional view of part of a wet cleaning apparatus including a separator according to a further example;

FIG. 10A shows a perspective view of a separator unit according to still another example;

FIG. 10B shows a cutaway view of the separator unit shown in FIG. 10A; and

FIG. 11 provides a flowchart of a method according to an example.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

Provided is a wet cleaning apparatus, such as a wet vacuum cleaner, which uses a separator unit for separating liquid and particles from a flow of air, e.g. a suction flow. The separator unit comprises a flow path member and an outlet member which adjoins or substantially adjoins the flow path member, and extends from the flow path member. The flow path member changes the flow direction of the flow of air such that any water and/or dirt particles entrained in the air are thrown against an interior surface portion of the flow path member. In this way, such water and/or dirt particles are separated from the flow of air. The outlet member has an opening to which the separated water and/or dirt particles are guided. The outlet member is arranged, when the apparatus is orientated for use, to guide and accumulate the separated water and/or dirt particles towards a region at the opening. The separated water and/or dirt particles flow from the region towards a collection volume along a first flow path. The air separated from the water and/or dirt particles is directed towards an air passage which is spaced apart from the outlet member and the collection volume. A second flow path for the separated air is provided between the opening of the outlet member and the air passage, which second flow path is directed away from the first flow path. This assists to minimise or prevent re-entrainment of the water and/or dirt particles in the flow of air. Further provided is a method of separating water and/or dirt particles from a flow of air.

Thus, the present disclosure may, for example, provide a solution which enables liquid separated from the air to be concentrated and guided towards the collection volume, while the dry or drier air moves towards the air passage. The air passage may, for example, define an exit of the separator unit. The present disclosure relates specifically to the design of separator unit of a wet cleaning apparatus, such as a wet vacuum cleaner. Before describing examples of the separator unit in detail, an example will be given of the general configuration of a wet vacuum cleaner. It should nevertheless be appreciated that the wet vacuum cleaner is described for the purpose of illustration only, and the separator unit may be used in wet cleaning apparatuses more generally.

Gas and liquid streams from the separation unit may thus be divided into respective downstream pathways with less risk of the relatively high velocity gas stream interfering with the separated liquid flow.

The separator unit is configured such that airflow within the outlet member and the liquid flowing on its inner surface are prevented from affecting each other significantly. This may be achieved by moving these flows in separate directions relative to each other. There may be some mutual influencing, however, where, for example, liquid is clinging to the edge of the opening while the air is flowing around it. Accordingly, the airflow and the flow of liquid may “slightly cross” each other. Thus, the airflow may only be “substantially prevented” from crossing the flow of the liquid. To keep droplets from re-joining the primary airflow, the outlet member may be designed such that the air speeds are sufficiently low.

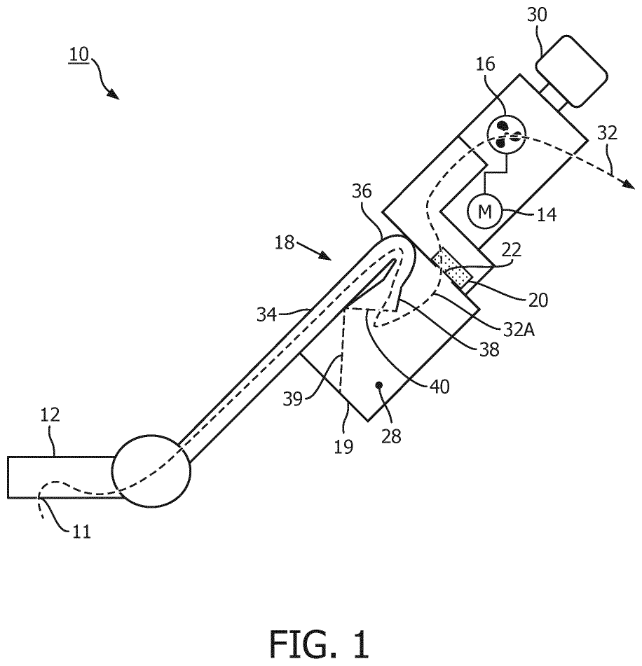

FIG. 1 shows a wet vacuum cleaner 10, comprising a dirt inlet 11 through which water and/or dirt particles, e.g. moist dirt particles, and air are sucked into the wet vacuum cleaner 10. As shown in FIG. 1, the dirt inlet 11 may be provided in a vacuum cleaner head 12.

The wet vacuum cleaner 10 comprises a motor 14 and a fan 16 for delivering suction to the dirt inlet 11. In the example shown in FIG. 1, the motor 14 and fan 16 delivers suction to the dirt inlet 11 provided in the vacuum cleaner head 12.

A separator unit 18 is provided for separating liquid and particles from the flow generated by the suction generated by the motor 14 and fan 16.

The motor 14, for example, comprises a bypass motor 14. This type of motor 14 can tolerate water content in the airflow, because the drawn in airflow is not used for motor cooling and is isolated from the motor parts. Instead, ambient air is drawn in to the motor 14 for cooling purposes.

The separator unit 18 may be regarded as being part of a wet dirt management system, which dirt management system may include additional filters. The dirt management system has a container 19 for collecting the separated moisture and dirt. This may be an integral part of the separator unit 18 or there may be a separate waste water collection reservoir to which the separator unit 18 connects. An outlet filter 20 may, for example, be provided between the outlet flow of the separator unit 18 and the motor 14 and fan 16, as shown.

An air passage 22 passes the air separated from the water and/or dirt particles towards the motor 14 and fan 16.

A collection volume 28 receives the water and/or dirt particles. The collection volume 28 may be, for example, provided below the separator unit 18 (when the wet vacuum cleaner 10 is upright) so that water is collected under gravity.

The air passage 22 is spatially removed from the collection volume 28 and parts of the separator unit 18 which transfer the separated water and/or dirt particles towards the collection volume 28. As shown in FIG. 1, an aperture in the container 19 may at least partly define the air passage 22. The aperture may be located, for example, at the top of the container 19 while the collection volume 28 is provided at the bottom of the container 19 (when the wet vacuum cleaner 10 is upright). Such an arrangement may assist to minimise the risk of the water and/or dirt particles being recombined with the air and passed downstream towards the motor 14 and fan 16.

There is a handle 30 at the opposite end to the vacuum cleaner head 12. The vacuum cleaner 10 shown is a stick vacuum cleaner so that in use the vacuum cleaner head 12 forms the only contact with the surface to be vacuumed. Of course, it may be an upright vacuum cleaner or a canister vacuum cleaner. The present disclosure relates to design features of the separator unit 18, and may be applied to any wet cleaning apparatus 10, and any wet vacuum cleaner 10.

The user may be required to deliver water to the surface being vacuumed independently of the vacuum cleaner 10. However, the wet dirt management system may instead also include a clean water reservoir (not visible) for delivering water to the vacuum cleaner head 12.

The vacuum cleaner head 12 may have, for example, a rotary brush (not visible) to which water is delivered from the clean water reservoir, and hence may also have an inlet for receiving water from the clean water reservoir. The vacuum cleaner head 12 is specifically designed to pick up wet dirt and optionally also perform the floor wetting.

The dotted line 32 schematically represents the flow of air passing through the wet vacuum cleaner 10. A tube 34 may carry the air from the dirt inlet 11 to the separator unit 18.

The separator unit 18 comprises a flow path member 36 which changes the direction of flow 32 through the wet vacuum cleaner 10. This flow direction change causes the water and/or dirt particles entrained in the air to be flung against an interior surface portion of the flow path member 36. In this way, the water and/or dirt particles are separated from the air.

A principal difference between water and air is that the water tends to stick to many types of solid materials, as well as to itself, while most gases will not. This principle is conveniently applied to, for example, separate water from air. Merely guiding a water-air mixture through a tube 34 may cause droplets and streams of liquid to form on the walls of the tube 34. But by guiding the mixture through a geometry that forces it to change direction as well (such as in a bend or a cyclone), liquids (as well as solids) will accumulate outwardly because of centrifugal forces. In doing so liquid will become adhered to, and flow along a wall against which the liquid is directed, while the dry or drier air will flow in the bulk.

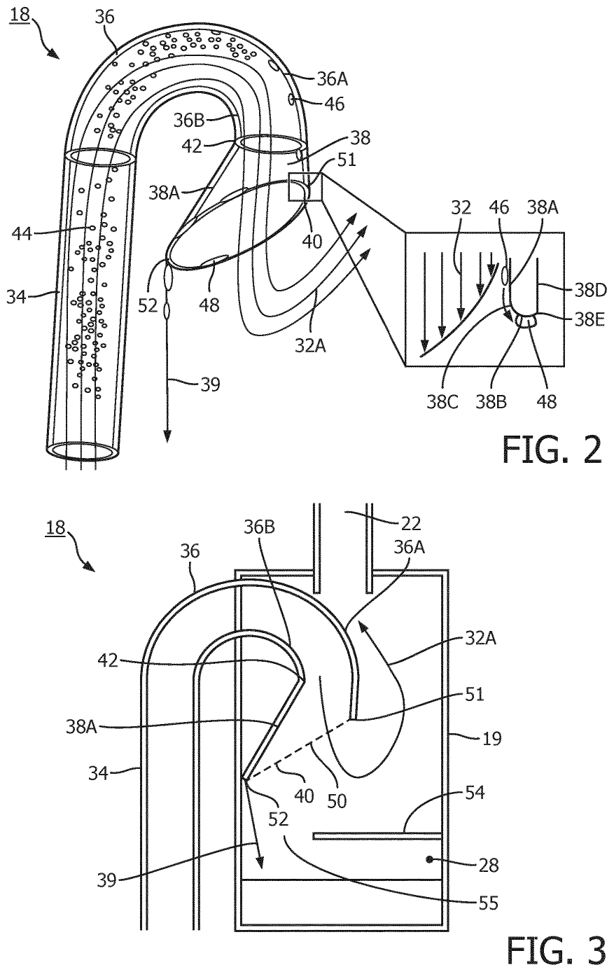

In the example shown in FIGS. 1 and 2, the flow path member 36 is defined by a curved tube section. An upstream end of the curved tube section 36 adjoins, e.g. is directly connected to, the tube 34.

The curved tube section 36 is U-shaped in the example shown in FIGS. 1 and 2 (and in FIGS. 3 to 6), such that the tube section 36 causes the direction of flow to change by 180°. This may facilitate efficient separation of the water and/or dirt particles from the air, although any suitable angle of flow direction change may be considered provided that the change of flow direction effects the requisite separation of the water and/or dirt particles from the air.

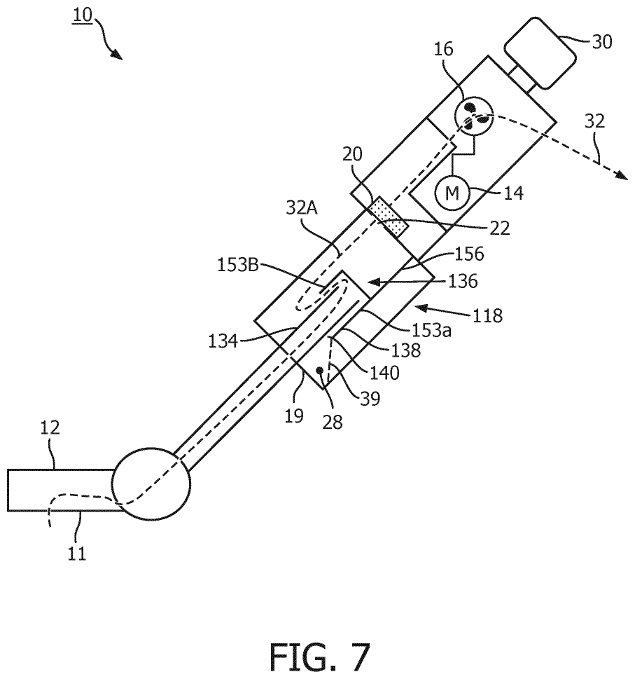

Moreover, the flow path member may have any suitable design provided that the change in direction of flow causes the water and/or dirt particles to be separated from the flow of air. In this respect, a different flow path member design will be described herein below with reference to FIGS. 7 to 10B.

The separator unit 18 further comprises an outlet member 38 which adjoins, e.g. is directly connected to, the flow path member 36. The outlet member 38 extends from the flow path member 36, and terminates at an opening delimited by a rim 40 of the outlet member 38.

The outlet member 38 adjoins the flow path member 36 at position 42. The outlet member 38 may, for example, be joined to the flow path member 36, e.g. using fasteners and/or a suitable adhesive. Alternatively, the outlet member 38 and the flow path member 36 may be integrally formed.

For example, the flow path member 36 and the outlet member 38 may be integrally formed in a single moulded, e.g. injection moulded, piece.

More generally, the separator unit 18 may be formed from any suitable material, such as a polymer, e.g. polypropylene.

The separated water and/or dirt particles are guided by the outlet member 38 towards the opening of the outlet member 38. The outlet member 38 may be configured such that air drag and gravity assists with this guiding of the water and/or dirt particles towards the opening. Moreover, the outlet member 38 is arranged to direct the separated water and/or dirt particles from the opening towards the collection volume 28 along a first flow path 39 when the apparatus 10 is orientated for use. The outlet member 38 may thus be alternatively termed a “liquid guiding structure”.

Such guiding and accumulating of the separated water and/or dirt particles by the outlet member may be implemented in any suitable manner. In the non-limiting example shown in FIG. 1, the opening of the outlet member 38 is delimited by a slanted rim 40. The slanted rim 40 is slanted such that the separated water and/or dirt particles flow along the slanted rim 40 to a region, e.g. a point, on the slanted rim 40 from which the first flow path 39 extends towards the collection volume 28. As shown in FIG. 1, gravity, together with air drag, may assist the separated water and/or dirt particles to flow along the first flow path 39 from the region, e.g. point, on the slanted rim 40.

The slanted rim 40 of the outlet member 38 may further assist in directing the flow of separated air away from the first flow path 39. This is because the airflow resistance may be higher on the side of the outlet member 38 towards which the water and/or dirt particles are guided by the slanted rim 40.

Alternatively or additionally, the outlet member 38 may comprise a water guiding element (not visible). The water guiding element may be arranged on or in a surface of the outlet member 38 and configured to guide the separated water and/or dirt particles to the opening and towards the collection volume 28 from the opening along the first flow path 39.

Such a water guiding element may, for example, comprise at least one of a rib protruding from an inner surface of the outlet member 38, and a groove in the inner surface of the outlet member 38. The water and/or dirt particles may, for example, be channelled by the rib(s) and/or groove(s) to the region, e.g. point, at the opening from which the first flow path 39 extends towards the collection volume 28.

As shown in FIG. 1, a second flow path 32A, which is included in the airflow path 32, is provided between the opening of the outlet member 38 and the air passage 22. The first flow path 39 is directed away from, and thus is substantially prevented from crossing, the second flow path 32A, which assists to minimise or prevent re-entrainment of the water and/or dirt particles in the flow of air.

FIG. 2 shows the flow path member 36 and the outlet member 38 of the separator unit 18 depicted in FIG. 1 in greater detail. As shown in FIG. 2, the water and/or dirt particles 44 entrained in the air flowing though the tube 34 are guided against the interior surface portion 36A of the flow path member 36 as a result of the change in flow direction. This may cause accumulation of the water and/or dirt particles into larger droplets 46 on the interior surface portion 36A, thereby assisting separation from the air.

In the example shown in FIG. 2, the interior surface portion 36A is defined by an outboard surface of the curved tube section 36. The change in direction imposed by the curved tube section 36 causes the water and/or dirt particles to be flung by centrifugal forces against the outboard surface 36A of the curved tube section 36. A further interior surface portion 36B is defined by an inboard surface of the curved tube section 36.

More generally, a locality, e.g. a corner, at which air separation occurs, due to the air being unable to follow the sudden change, may result in a “wake” corresponding to a lower speed airflow region. Such a corner may, for example, be provided at the position 42 at which the interior surface portion 36A meets an inner surface 38A of the outlet member 38. The angle of such a corner may, for example, be greater than 7°. Such an angle may assist to ensure efficient separation of the air from the liquid and/or dirt particles.

As shown in FIG. 2, the slanted rim 40 causes further accumulation of the water and/or dirt particles into droplets 48 as they are guided along the slanted rim 40 in a direction from a first region 51, in other words an “uppermost point” 51 on the slanted rim 40 when the apparatus 10 is orientated for use, towards a second region 52. The region 52 may be alternatively termed a “lowermost point” 52 on the slanted rim 40 when the apparatus 10 is orientated for use.

The droplets 48 of the separated water and/or dirt particles flow along the slanted rim 40 and towards the collection volume 28. The slanted rim 40 may thus slope in the direction of the collection volume 28. The separated water and/or dirt particles flow along the slanted rim 40 towards the lowermost point 52 on the slanted rim 40. The first flow path 39 may extend towards the collection volume 28 from the lowermost point 52.

Gravity, as well as air drag, may assist the droplets 48 to flow along the slanted rim 40 towards the lowermost point 52 on the rim 40. Moreover, gravity may assist the separated water and/or dirt particles to flow along the first flow path 39 from the lowermost point 52 towards the collection volume 28.

The outlet member 38 has an inner surface 38A which extends from the interior surface portion 36A of the flow path member 36. As best shown in the inset of FIG. 2, the outlet member 38 further comprises a first outer surface 38B which opposes the collection volume 28, and a curved surface 38C between the inner surface 38A and the first outer surface 38B. The separated water and/or dirt particles are guided by the curved surface 38C from the inner surface 38A to the first outer surface 38B. In this way, the droplets 48 may be guided to the first outer surface 38B and, in the case of the slanted rim 40 of this non-limiting example, the droplets 48 may flow along the first outer surface 38B towards the lowermost point 52.

As also shown in the inset of FIG. 2, the outlet member 38 further comprises a second outer surface 38D. The first outer surface 38B meets the second outer surface 38D at a defined edge or corner 38E. This edge 38E assists to retain the droplets 48 on the first outer surface 38B, partly as a consequence of their wetting properties, thereby to assist the passage of the droplets 48 along the first outer surface 38B towards the lowermost point 52 of the slanted rim 40.

Thus, at the opening, the liquid may accumulate on the first outer surface 38B. Again, forced by air and gravity, the accumulated liquid follows the contour of the slanted rim 40 towards a single focus region or point, in other words the lowermost point 52. From here on the liquid that was previously distributed on the interior surface portion 36A of the flow path member 36 and the inner surface 38A of the outlet member 38 may now be accumulated and can be guided towards the collection volume 28 along the first flow path 39 in a controlled manner.

In an embodiment, a flow-through area of the outlet member 38 increases towards the opening. In other words, the cross-sectional area of the interior of the outlet member 38 may increase towards the opening. This may assist to keep the droplets 48 separated from the airflow because the air speed through the outlet member 38 is correspondingly decreased. In other words, by increasing the cross-sectional area of the outlet member 38 towards the opening, the liquid may be exposed to a lower speed airflow, and may thus be less likely to be re-entrained in the airflow.

In the non-limiting example shown in FIGS. 1 and 2, the outlet member 38 comprises a conical portion, e.g. an asymmetric conical portion. The flow-through area of the outlet member 38 thus widens towards the opening. It should nevertheless be noted that other cross-sectional shapes of the widening outlet member 38 may also be contemplated, such as square, rectangular, triangular, and so on. The conical portion 38 adjoins, e.g. directly connects with, a downstream end of the curved tube section 36.

As shown in FIG. 2, the conical portion is truncated at the opening, thereby to define the slanted rim 40. The slanted rim 40 in combination with the widening flow-through area of the outlet member 38 may provide a particularly suitable arrangement for guiding the water droplets 48 towards the opening and onwards along the first flow path 39 towards the collection volume 28 with reduced risk of re-entrainment in the airflow.

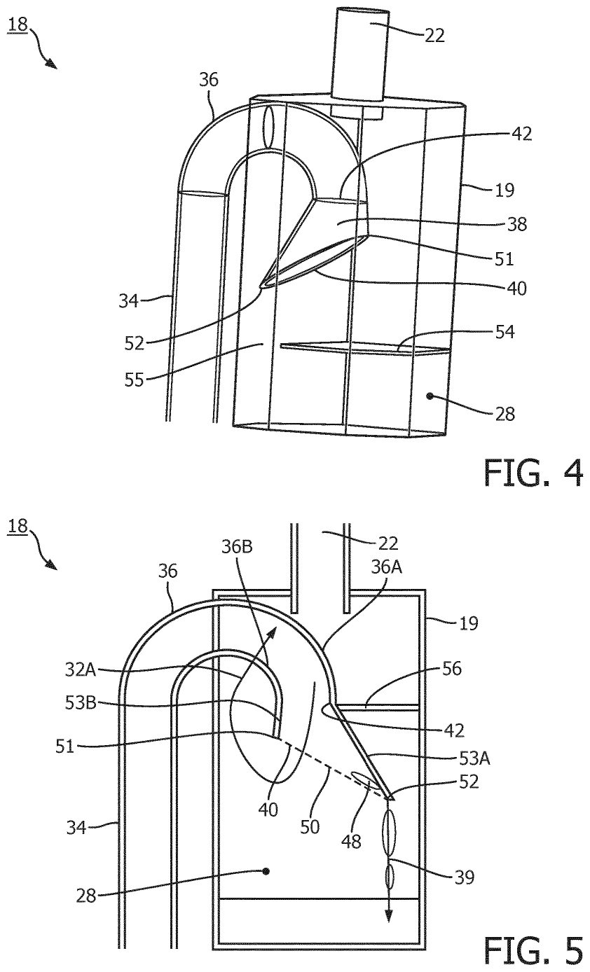

FIG. 3 provides a cross-sectional view of the separator unit 18. FIG. 4 provides a perspective view of the part shown in FIG. 3. In this example, the outlet member 38 is defined by an asymmetric conical portion. The slanted rim 40 is defined by a truncation of the conical portion by the plane 50.

In an embodiment, the second flow path 32A of the air from the opening of the outlet member 38 towards the air passage 22 may be determined by the spatial arrangement of the outlet member 38, and particularly the opening, relative to the air passage 22.
As shown in FIGS. 3 and 4, the outlet member 38 has a first side 53A and a second side 53B. In this particular example, the first side 53A opposes the second side 53B. The outlet member 38 is arranged when the apparatus 10 is orientated for use such that the separated water and/or dirt particles are accumulated and guided towards the first side 53A. As best shown in FIG. 3, the first side 53A terminates at the lowermost point 52 of the outlet member 38, from which the first flow path 39 extends.

The air passage 22 is positioned proximal to the second side 53B, and distal with respect to the first side 53A. This geometry may result in the second flow path 32A being directed away from the first side 53A and towards the air passage 22. In this way, the second flow path 32A is directed away from, and is substantially prevented from crossing, the first flow path 39.

In the example shown in FIGS. 3 and 4, the volume of the container 19 includes the collection volume 28, and also houses part of the separator unit 18. Moreover, the apparatus 10 further comprises partition 54. The collection volume 28 is delimited by walls of the container 19 and the partition 54.

In this particular example, the first flow path 39 is directed past the partition 54 and towards the collection volume 28. In other words, the first flow path 39 is directed towards a gap 55 between the partition 54 and the walls of the container 19.

The lowermost point 52 of the slanted rim 40 may be aligned with the gap 55 such that the water and/or dirt droplets 48 accumulating towards the lowermost point 52 are directed through the gap 55 and into the collection volume 28.

In the example depicted in FIGS. 3 and 4, the wall of the container 19 is closer to the first side 53A than to the second side 53B of the outlet member 38, such that greater resistance to airflow is provided between the first side 53A and the air passage 22 than between the second side 53B and the air passage 22. Thus, the airflow is preferentially drawn from the opening of the outlet member 38 towards the air passage 22 along the second flow path 32A.

It is emphasised that the second flow path 32A may be defined in any suitable manner. In an embodiment, a shielding member 56 is arranged to block airflow from the first side 53A of the outlet member 38 (towards which the water and/or dirt particles are guided) to the air passage 22. In this case, the second flow path 32A is provided between the second side 53B of the outlet member 38 and the air passage 22.

In the non-limiting example shown in FIG. 5, such a shielding member 56 extends from the outlet member 38 to a lateral side wall of the container 19. In particular, the shielding member 56 extends from the first side 53A of the outlet member 38 to the lateral side wall of the container 19. Thus, the resistance to airflow caused by the shielding member 56 may assist to define the second flow path 32A between the second side 53B and the air passage 22.

As shown in FIG. 5, the first flow path 39 from the first side 53A of the outlet member 38 towards the collection volume 28 is directed away from, and is substantially prevented from crossing, the second flow path 32A from the second side 53B of the outlet member 38 towards the air passage 22.

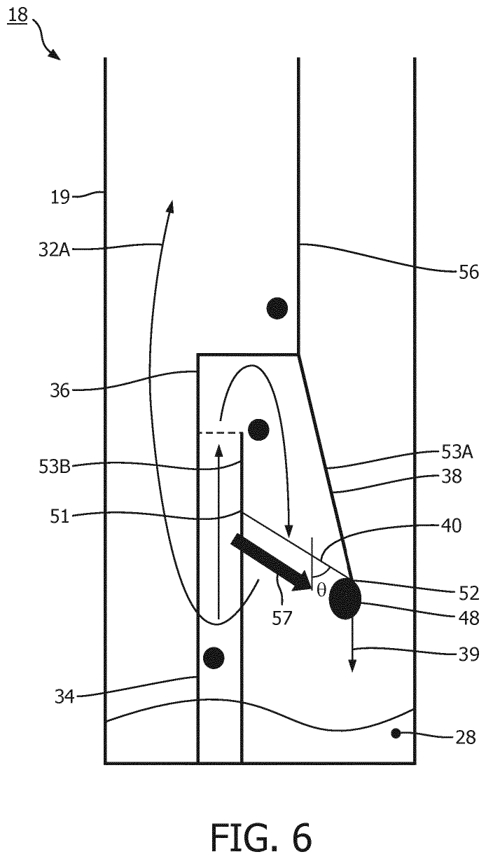

FIG. 6 shows another exemplary separator unit 18. In this example, the shielding member 56 extends from the outlet member 38 to an end wall (not visible) of the container 19, in other words an upper end wall of the container 19 when the apparatus 10 is orientated for use. Similarly to the example shown in FIG. 5, the shielding member 56 blocks the path of airflow from the first side 53A of the outlet member 38 (towards which the water and/or dirt particles are guided) towards the air passage 22. The second flow path 32A is correspondingly defined between the second side 53B of the outlet member 38 and the air passage 22. In this way, the first flow path 39 from the first side 53A of the outlet member 38 towards the collection volume 28 is directed away from, and is substantially prevented from crossing, the second flow path 32A from the second side 53B of the outlet member 38 towards the air passage 22.

As shown in FIG. 6, the droplets 48 are guided towards the lowermost point 52 of the slanted rim 40, as previously described. This is indicated in FIG. 6 by the arrow 57.

An angle θ is defined between the airflow direction within the outlet member 38 and the direction in which the separated water and/or dirt particles are transported towards the lowermost point 52 of the slanted rim 40. This angle θ is greater than 0°, and less than or equal to 90°, such as 20° to 75°, e.g. about 45°.

FIG. 7 shows a wet vacuum cleaner 10 according to a further example. Similarly, to the examples depicted in FIG. 1 to 6, a tube 134 carries the air from the dirt inlet 11 to the separator unit 118. But in this example, a cup receives an end of the tube 134, and the first interior surface portion 136A of the flow path member 136 is defined by an interior surface of the cup. The cup is spaced apart from the end of the tube 134, thereby to allow the air to flow between the end of the tube 134 and the cup towards the air passage 22.

The cup causes the direction of flow 32 to change in an analogous manner to the U-shaped tube section 36 described above in relation to FIGS. 1 to 6. This may cause the water and/or dirt particles to be flung against the interior surface 136A of the cup, and thereby be separated from the flow of air.

In this example, the outlet member 138 is defined by a downstream portion of the cup. This downstream portion 138 adjoins, e.g. is directly connected to, an upstream portion of the cup which implements the flow direction change. The flow path member 136 and the outlet member 138 may thus, for example, be integrally formed.

As described above in relation to FIGS. 1 to 6, the separated water and/or dirt particles are guided, with the assistance of gravity and air drag, by the outlet member 138 towards the opening of the outlet member 138. The arrangement of the outlet member 138 is also such that the separated water and/or dirt particles are directed from the opening towards the collection volume 28 along the first flow path 39 when the apparatus 10 is orientated for use, as previously described.

Such directing of the separated water and/or dirt particles along the first flow path 39 may be implemented in any suitable manner. In the non-limiting example shown in FIG. 7, the downstream portion 138 of the cup comprises, or consists of, a rim 140 of the cup. The rim 140 of the cup is slanted such that the separated water and/or dirt particles flow along the slanted rim 140 to a region, e.g. point, on the slanted rim 140 from which the first flow path 39 extends towards the collection volume 28.

In the example shown in FIG. 7, the outlet member 138 has a first side 153A and a second side 153B, and in this example the first side 153A opposes the second side 153B. The outlet member 138 is arranged when the apparatus 10 is orientated for use such that the separated water and/or dirt particles are accumulated and guided towards the first side 153A. The first side 153A terminates at the lowermost point of the outlet member 138, from which the first flow path 39 extends.

The shielding member 156 provides an airflow barrier for restricting airflow from the first side 153A to the air passage 22. This arrangement may result in the second flow path 32A being directed away from the first side 153A and towards the air passage 22. In this way, the second flow path 32A is directed away from, and is substantially prevented from crossing, the first flow path 39.

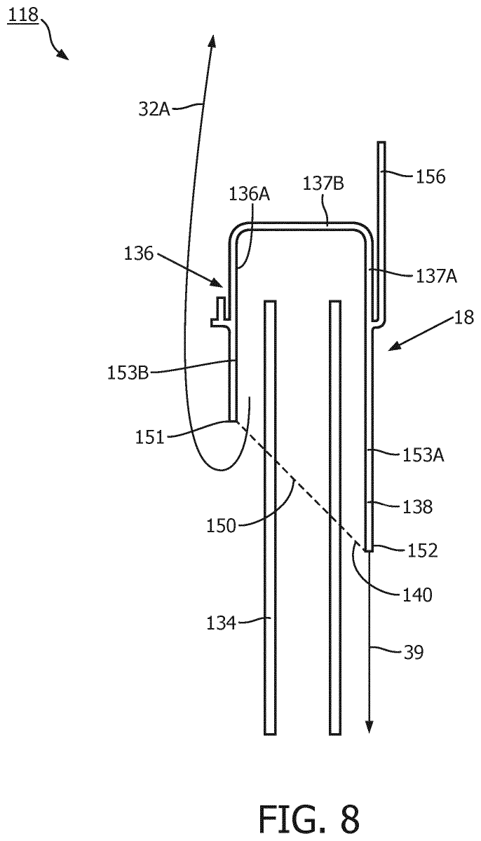

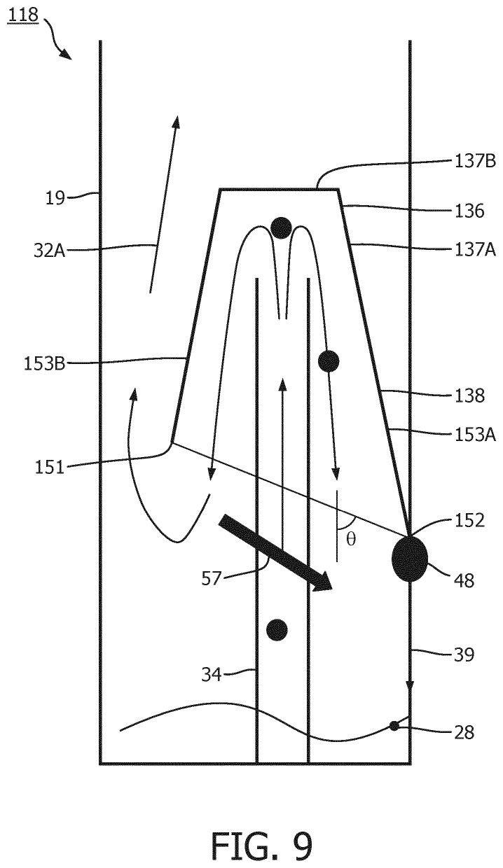

FIG. 8 provides a cross-sectional view of the separator unit 118 included in the wet vacuum cleaner 10 shown in FIG. 7. The cup has a cylindrical side wall 137A extending from a base 137B. The side wall 137A extends perpendicularly to a plane of the base 137B. This geometry leads to a 180° change in the direction of flow 32, which may facilitate efficient separation of the water and/or dirt particles from the air. It should nevertheless be noted that any suitable angle of flow direction change may be considered, e.g. by the side wall 137A extending non-perpendicularly from the base 137B, provided that the change of flow direction effects the requisite separation of the water and/or dirt particles from the air. An example of this will be described herein below with reference to FIG. 9.

In a non-limiting example, the side wall 137A extends perpendicularly from a plane of the base 137B, and the outlet member 138 may be defined by a flared portion of the cup which adjoins the side wall 137A. In this way, the flow direction change may be 180°, but the flared portion may assist to avoid liquid/dirt re-entrainment, as previously described.
Gravity, as well as air drag, may assist the droplets 48 to flow along the slanted rim 140 in a direction away from the uppermost point 151 of the rim 140 and towards the lowermost point 152 of the rim 140. Moreover, gravity may assist the separated water and/or dirt particles to flow along the first flow path 39 from the lowermost point 152 towards the collection volume 28, as previously described.

The outlet member 138 has an inner surface 138A which extends from the interior surface portion 136A of the flow path member 136. Whilst not visible in FIG. 8, the outlet member 138 may further comprise a first outer surface which opposes the collection volume 28, and a curved surface between the inner surface 138A and the first outer surface. The separated water and/or dirt particles are guided by the curved surface from the inner surface 138A to the first outer surface.

Moreover, the outlet member 138 may further comprise a second outer surface, and the first outer surface meets the second outer surface at a defined edge or corner, thereby to assist to retain the droplets 48 on the first outer surface, as previously described in relation to the inset of FIG. 2.

FIG. 8 also shows part of the shielding member 156 which extends from the outlet member 138, which is part of the cup in this example, to a wall of the container 19. This shielding member 156 assists to define the second flow path 32A, as previously described.

Whilst the tube 134 is located centrally in the cup in the examples shown in FIGS. 7 and 8, this is not intended to be limiting. In this respect, the tube 134 may, for example, be off-centre with respect to the cup.

The slanted rim 140 of the outlet member 138 may further assist in directing the flow of separated air away from the first flow path 39, since the airflow resistance may be higher on the first side 153A of the outlet member 138 towards which the water and/or dirt particles are guided by the slanted rim 140. In other words, a lower speed airflow region is defined by the first side 153A, since the air has to travel further before reaching the opening.
This second flow path 32A may, for example, be further controlled by using the location of the tube 134 with respect to the cup. Moving the tube 134 further towards the first side 153A may increase the airflow resistance, thereby to increase the propensity for the air to exit the opening at the second side 153B of the cup.

As shown in FIG. 8, the slanted rim 140 is provided by the cylindrical side wall 137A being truncated on a plane 150 angled to the plane of the base 136B. However, alternative designs are conceivable. FIG. 9, for example, shows a cup having a side wall 137A which extends at an angle to the plane of the base 137B, such that the flow-through area of the outlet member 138 widens towards the opening. This may assist to keep the droplets 48 separated from the airflow because the air speed through the outlet member 138 is correspondingly decreased, as previously described.

The separator unit 118 shown in FIG. 9 may otherwise be regarded as analogous to the separator unit 18 shown in FIG. 6, and the description of its operation, the angle θ, etc., will accordingly not be repeated for the sake of brevity.

The separator unit 118 may, for example, be contained, together with the collection volume 28, in the container 19. The cup of the separator unit 118 is arranged above the collection volume 28, when the wet vacuum cleaner 10 is orientated for use, such that water and/or dirt droplets 48 descend, assisted by gravity, from the slanted rim 140 into the collection volume 28.

In an embodiment, the container is partly delimited by an end wall 160 in which the air passage 22 is provided. In this non-limiting example, the end wall 160 opposes the collection volume 28 across the container 19. Thus, the air passage 22 may be spaced apart from the collection volume 28 across the container 19.

Whilst not visible in FIG. 7 to 9, the outlet member 138, in this case the downstream portion of the cup, may further comprise a water guiding element configured to guide the separated water and/or dirt particles to the opening and towards the collection volume 28 along the first flow path 39. The water guiding element may be arranged on or in the inner surface 138A of the cup, e.g. in the inner surface 138A of a downstream portion 138 of the cup. The water guiding element may, for example, comprise a rib protruding from the inner surface 138A, and/or a groove in the inner surface 138A, as previously described.

Whilst not visible in FIG. 7 to 9, the wet vacuum cleaner 10 may include a partition. The collection volume 28 may thus be delimited by walls of the container 19 and the partition, similarly to the examples shown in FIGS. 3 and 4.

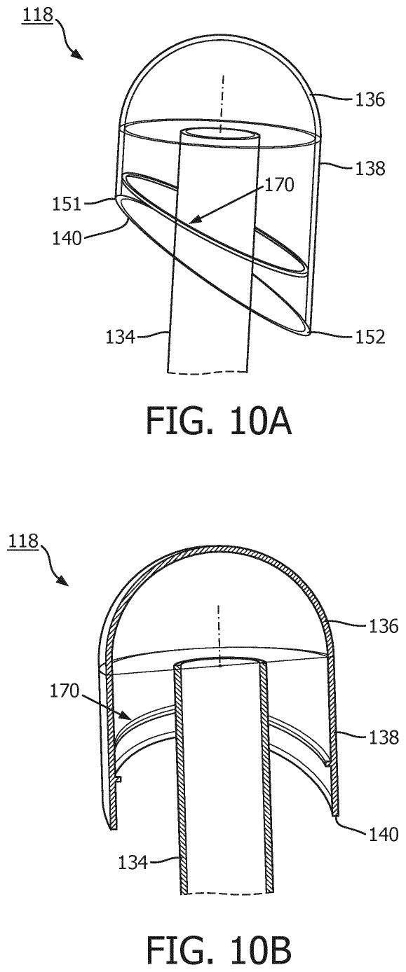

FIGS. 10A and 10B provide views of another exemplary separator unit 118. This separator unit 118 has a similar “tube-in-cup” design as explained above in relation to FIGS. 7 to 9. Moreover, a water guiding element 170 is included in the outlet member 138 for guiding the separated water and/or dirt particles to the region 152 at the opening from which the first flow path 39 extends towards the collection volume 28. In this particular example, the water guiding element 170 is provided in addition to the slanted rim 140 of the cup, but in other examples the water guiding element 170 may be used instead of the slanted rim 140 for guiding the water and/or dirt particles towards the region 152 at the opening from which the water and/or dirt particles flow along the first flow path 39 towards the collection volume 28.
In the example shown in FIGS. 10A and 10B, the water guiding element 170 comprises a rib which protrudes from the inner surface of the outlet member. The rib defines a channel along which the water and/or dirt particles flow towards the region 152. As shown, the rib, e.g. a helical rib, may extend around at least a portion of the circumference of the inner surface and in the direction of the opening.

In FIGS. 10A and 10B, the rib is depicted as a full rib but may alternatively be a subsection of the rib as shown. Alternatively or additionally, the water guiding element 170 comprises a groove in the inner surface of the outlet member 138.

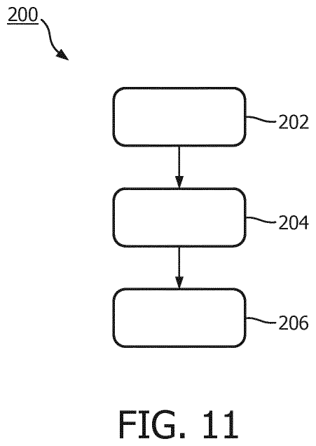

The liquid on the inner surface thus finds an obstruction in its path where it is more favourable to follow the rib and/or groove towards the intended collecting location, in other words the region 152, instead of moving “down” towards the opening and then to this location. It can be seen as an additional cup-edge e.g. to accommodate larger water volumes.
FIG. 11 provides a flowchart of a method 200 of separating water and/or dirt particles from a flow of air using a flow path member having an interior surface portion, an outlet member extending from the flow path member to an opening, a collection volume, and an air passage spaced apart from the outlet member and the collection volume. The flow path member, the outlet member, the collection volume, and the air passage may, for example, be as described in any of the embodiments described above in relation to the wet cleaning apparatus 10.

The method 200 comprises generating 202 a flow of air comprising entrained water and/or dirt particles. In 204, the flow path member is used to change a flow direction of the flow of the air such that the water and/or dirt particles are flung against the interior surface portion and thereby separated from the air. In 206, the separated water and/or dirt particles are guided and accumulated towards a region, e.g. a point, at the opening of the outlet member. The separated water and/or dirt particles flow from the region towards the collection volume along a first flow path. The air separated from the water and/or dirt particles is passed towards the air passage along a second flow path which is directed away from the first flow path.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A wet cleaning apparatus (10), comprising:
a dirt inlet (11);
a motor (14) and fan (16) for delivering suction to the dirt inlet;
a separator unit (18, 118) for separating water and/or dirt particles from a flow of air generated by the suction;
a collection volume (28) for collecting the separated water and/or dirt particles, wherein the separator unit comprises:
a flow path member (36, 136) having an interior surface portion (36A, 136A), the flow path member being arranged to change a flow direction of the flow of air such that the water and/or dirt particles are flung against the interior surface portion and thereby separated from the air; and
an outlet member (38, 138) extending from the flow path member to an opening, wherein the outlet member is arranged to guide and accumulate the separated water and/or dirt particles towards a region (52, 152) at the opening from which the separated water and/or dirt particles flow towards the collection volume along a first flow path (39) when the apparatus is orientated for use; and
an air passage (22) for passing the air separated from the water and/or dirt particles towards the motor and fan, the air passage being spaced apart from the outlet member and the collection volume, a second flow path (32A) being defined between the opening and the air passage, which second flow path is directed away from the first flow path.

2. The wet cleaning apparatus (10) according to claim 1, wherein the opening is delimited by a slanted rim (40, 140), the slanted rim being slanted such that the separated water and/or dirt particles flow along the slanted rim towards the region (52, 152).

3. The wet cleaning apparatus (10) according to claim 1 or claim 2, wherein the outlet member (38, 138) comprises a water guiding element, the water guiding element being arranged on or in an inner surface (38A, 138A) of the outlet member and configured to guide the separated water and/or dirt particles towards the region (52, 152); optionally wherein the water guiding element comprises at least one of a rib protruding from the inner surface of the outlet member, and a groove in the inner surface of the outlet member.

4. The wet cleaning apparatus (10) according to any of claims 1 to 3, wherein a flow-through area of the outlet member (38, 138) increases towards the opening.

5. The wet cleaning apparatus (10) according to any of claims 1 to 4, wherein the outlet member (38, 138) has a first side (53A, 153A) opposing a second side (53B, 153B), the first side extending to the region (52, 152), and wherein the second flow path (32A) extends from the opening at the second side and towards the air passage (22).

6. The wet cleaning apparatus (10) according to claim 5, comprising a shielding member (56, 156) extending from the first side (53A, 153A), the shielding member being thereby arranged to block flow of air along the first side towards the air passage (22).

7. The wet cleaning apparatus (10) according to any of claims 1 to 6, wherein the outlet member (38, 138) comprises:
a first outer surface (38B) at the opening, which first outer surface is substantially perpendicular to an airflow direction within the outlet member (38, 138); and
a curved surface (38C) for guiding the separated water and/or dirt particles in the outlet member to the first outer surface.

8. The wet cleaning apparatus (10) according to claim 7, wherein the outlet member (38, 138) further comprises a second outer surface (38D) which meets the first outer surface (38B) at an edge (38E).

9. The wet cleaning apparatus (10) according to any of claims 1 to 8, comprising a tube (134) for delivering said airflow to the separator unit (118), wherein a cup receives an end of the tube, said interior surface portion (136A) of the flow path member (136) being defined by an interior surface of the cup which is spaced apart from the end of the tube.

10. The wet cleaning apparatus (10) according to claim 9, wherein the outlet member (138) is defined by a downstream portion of the cup, which downstream portion comprises a rim of the cup, optionally wherein the rim (140) of the cup is slanted such as to define a slanted rim along which water and/or dirt particles flow towards the region (152).

11. The wet cleaning apparatus (10) according to any of claims 1 to 8, comprising a tube (34) for delivering said flow of air to the separator unit (18), wherein the flow path member

(36) is defined by a curved tube section (36) having an upstream end and a downstream end, the upstream end adjoining the tube.

12. The wet cleaning apparatus (10) according to any of claims 1 to 11, comprising a container (19) whose volume includes the collection volume (28), wherein the container further houses at least part of the separator unit (18).

13. The wet cleaning apparatus (10) according to claim 12, wherein the apparatus further comprises a partition (54), the collection volume (28) being delimited by walls of the container (19) and the partition, and wherein the first flow path (39) is directed past the partition and towards the collection volume.

14. The wet cleaning apparatus (10) according to claim 12 or claim 13, wherein the container (19) is partly delimited by an end wall (160) in which the air passage (22) is provided.

15. A method (200) of separating water and/or dirt particles from a flow of air using a flow path member having an interior surface portion, an outlet member extending from the flow path member to an opening, a collection volume, and an air passage spaced apart from the outlet member and the collection volume, the method comprising:
generating (202) a flow of air comprising entrained water and/or dirt particles;
using (204) the flow path member to change a flow direction of the flow of the air such that the water and/or dirt particles are flung against the interior surface portion and thereby separated from the air;
using (206) the outlet member to accumulate and guide the separated water and/or dirt particles towards a region at the opening from which the separated water and/or dirt particles flow towards the collection volume along a first flow path, wherein the air separated from the water and/or dirt particles is passed towards the air passage along a second flow path which is directed away from the first flow path.
